(19) United States
(12) Patent Application Publication
(10) Pub. No.: US 2015/0024707 A1
(43) Pub. Date: Jan. 22, 2015

(54) System And Method For Resource Usage, Performance And Expenditure Comparison

(71) Applicants: Christopher J. DeBenedictis, Branford, CT (US); Paul Schmidt, Rocky Hill, CT (US); Kenneth Scott Fassman, Redding, CT (US)

(72) Inventors: Christopher J. DeBenedictis, Branford, CT (US); Paul Schmidt, Rocky Hill, CT (US); Kenneth Scott Fassman, Redding, CT (US)

(21) Appl. No.: 14/094,112

(22) Filed: Dec. 2, 2013

Related U.S. Application Data
(60) Provisional application No. 61/856,341, filed on Jul. 19, 2013.

(51) Int. Cl. H04M 15/00

(52) U.S. Cl. CPC H04M 15/49
USPC 455/406; 455/405

(57) ABSTRACT

Provided is a system for comparing telecommunications resources between a first company and a group of companies. A storage is accessible by a system computer, the computer having a network connection. An interface module allows the first company to access the system computer, and a comparison module receives a comparison request. The comparison request includes a group selection and a criteria selection that includes telecommunications services criteria associated with a telecommunication. The comparison module compares the telecommunications services criteria data related to the first company with telecommunications services criteria data related to the group. A telecommunications metric module generates a telecommunications metric related to the comparison of the telecommunications services criteria data of the first and second companies. The telecommunications metric is accessible to a user computer allowing the first company to see how their telecommunications profile compares to the telecommunications profile of the group.

### FIELD OF THE INVENTION

The present invention relates to a system and method for comparing resource usage, performance and expense. In one aspect, the system allows one entity to compare their telecommunications usage, performance and expenses to companies or groups of companies according to user selected characteristics and metrics.

### BACKGROUND OF THE INVENTION

As companies strive to communicate better both within the company and to customers, there are a growing number of devices using the company telecom or network connections. Further, as companies grow, shrink or shift focus, different resources are required. In the example of telecommunications, larger companies may require rather high bandwidths due to the particular usage requirements or due to the number of devices on the network. Requirements can vary depending on the industry, location or a number of other factors. Frequently, a company will contract with a service provider for their required bandwidth, download speeds, upload speeds and data usage. With the increase in number of wireless devices such as cell phones, smart phones, tablets, laptops and the like, various network, telecom and wireless connections are necessary to provide effective communication. At the same time, companies are constantly striving to trim costs to improve profitability.

One way to manage costs associated with telecom, network and wireless connections is to monitor the performance of the various networks in accordance with contracted rates. If the performance falls below a target, it is often possible to request a credit for the resource that was not adequately provided by the service provider. Another way to manage costs is to monitor usage of resources to be sure that the company is contracted for the correct amount of data, bandwidth or other performance characteristic. If a company uses more than it contracts for, there can be expensive overages that can significantly drive up the cost of the service. At the same time, if the company contracts for more than it needs, the service will be more expensive than necessary.

It is therefore desired to provide for a way for companies to compare their resource performance, usage and/or expenditures to other companies or groups of companies.

### SUMMARY OF THE INVENTION

One aspect of the system allows a company a way to compare their resource performance, usage and expenditures to companies or groups of companies. The groups may be companies in the same or similar space or sector. The comparison may also be done across divisions within the company. The groups may be user selectable based on a number of different factors. The company may wish to compare their expenses to other entities of similar size and/or with similar requirements in order to get a better understanding of how the company's costs compare relative to the costs of other companies. This may allow the company to determine how to reduce costs or how to better allocate expenditures.

Another aspect of the system allows a company to compare across outside companies or across groups or divisions within the company. This can allow a company to determine how to be more efficient or effective in different areas of operations.

Therefore, it is an object to provide a system allowing a company to evaluate the company's telecom expenditures in a selected context.

Another object is to provide a system allowing a company to evaluate the company's resource usage, expense and/or performance in a selected context.

Still other objects are to provide a system allowing a scalable and variable context that may be selected by a user to customize the evaluation.

Yet further objects are to provide a system allowing customized comparisons and reporting relative to resource usage, expenditures and performances.

These and other objects are achieved by providing a system for comparing resources delivered to one company to resources delivered to a group of similar companies.

Other objects are achieved by providing a system having a number of pre-set reports and criteria for use in comparing one company's telecommunication profile to another company's telecommunication profile.

Other objects are achieved by providing a system for comparing telecommunications resource performance between a first company, which, for example, may be a client company, and a second company, which, for example, may be a different company in the same or similar industry as the client company. The system may include a system computer with a network connection, and a storage accessible by the system computer. An interface module may allow the first company to access the system computer via a user computer. A comparison module may receive a comparison request from the user computer. The comparison request may include a group selection that includes at least the second company or a group of companies, and a criteria selection that includes telecommunications services criteria associated with a telecommunications service for both the first and second company or group of companies. The comparison module compares the telecommunications services criteria data related to the first company with telecommunications services criteria data related to the second company or group of companies. Telecommunication services criteria data may include data for calculating criteria selected for comparison. One example of this data could be the total expenditures on directory assistance, which could be used to calculate the % Directory Assistance criteria discussed further herein. A telecommunications metric module may then generate a telecommunications metric related to the comparison of the telecommunications services criteria data of the first and second companies or group of companies. A reporting module allows the telecommunications metric to be accessible to the user computer. The metric allows the first company to determine how their telecommunications profile compares to the telecommunications profile of the second company or group of companies.

Other objects are achieved by providing a system for comparing telecommunications resources between a first company and a group of companies. The group of companies having a plurality of companies associated therewith, where the group may be user selected or automatically selected based on the first company's industry, sector, size, expenditures or other. The first company may be a client company, and the group may be companies in a similar field, industry or sector. The system may further allow for customized settings for selection of the group. The system includes a system computer having a network connection and a storage accessible by the system computer, the storage receiving company data from the first company and each of the plurality of companies associated with the group of companies, the company data may include data indicative of company sector, company industry, company revenue and the telecommunication expenditures of the companies. The company data may be associated with a telecommunications service for the first company and the group of companies it is understood that the company data may include telecommunications services criteria data. An interface module allows the first company to access the system computer with a user computer. A comparison module receives a comparison request from the user computer, the comparison request including a group selection indicative of the plurality of companies. It is understood that the plurality of companies may be in the same or similar sector, or the same or similar industry as the first company. The group selection may further be indicative of a range of revenue and a range of telecommunication expenditures. It is understood that the plurality of companies may be within the range of revenue and range of telecommunication expenditures.

The comparison request may further include a criteria selection having telecommunications services criteria associated with a telecommunications service provided to both the first and second company. The comparison module may compare a first telecommunications services criteria data related to the first company with a second telecommunications services criteria data related to the second company. A telecommunications metric module may generate a telecommunications metric related to the comparison of the first telecommunications services criteria data and the second telecommunications services criteria data. A reporting module allows the telecommunications metric to be accessible to the user computer allowing the first company to determine how the telecommunications profile of the first company compares to the telecommunications profile of the second company.

The comparison request may further include a criteria selection that takes into consideration seasonal or time based fluctuations in usage and compares like intervals that may occur on a cyclical basis. For example, end of month usage, or summer time slow periods, or Christmas rush periods can be compared to eliminate any variances based on these seasonal or cyclical variances.

Other objects are achieved by providing a system for resource comparison having a system computer with a processor with software executing thereon and a storage accessible by the system computer. The storage is for storing entity data indicative of resource use of a plurality of entities. Software executing on the system computer receives a comparison request, the comparison request including a group selection and a criteria selection, the group selection indicative of at least one group of one or more entities and the criteria selection indicative of at least one criteria for comparison. Software executing on the system computer receives first company data relating to the criteria for the first company. Software executing on the system computer receives group data relating to the criteria for the at least one group of one or more entities. Software executing on the system computer for generating a metric by comparing the first company data to the group data according to the selected at least one criteria, the metric for transmission to a user computer. It is understood that comparisons may be carried out based on performance or service level ranges, where the companies or resources compared have similar service levels associated with the resource or services.

The service level would be associated with the characteristics of a particular resource and the agreed upon or actually delivered levels. For example, the cost of telecommunication service may increase as the service level increases. A telecommunication service level may include, for example, a particular bandwidth, upload speed, download speed, amount of data and number of minutes. The service level may also be associated with the actual or approximated performance associated with a particular resource. For example, if the contracted service level of an internet connection is for 18 megabytes per second download speed, the actual or approximated service level delivered could be more or less than 18 megabytes per second in this example. The service level relevant for comparison may change with the particular resource. For example, if the resource comparison is automotive fuel, the service level may be a certain octane rating or an energy measurement such as BTU/gal. The actual or approximated service level would then be the actual or approximated performance of the fuel delivered, for example, if the service level of diesel is 128,450 Btu/gal the actual or approximated service level could be higher or lower for the fuel that is actually delivered.

The service range would be a particular range of service levels that is used for selecting similar services for comparison between companies of groups of companies. A service range associated with the 18 megabyte per second service level could be 16-20 megabytes per second. This service range would be used to select from services provided to companies where the services provided are between 16 and 20 megabytes per second of download speed. This may allow for the comparison to more accurately compare services that are similar. It is understood that the service range may be pre-set or automatically determined by the system depending on the resource or service to be compared. The service range could also be manually set. The service range could also be made up of a combination of variables that determine a service level quality which may include but not be limited to burst speed, latency, jitter, as well as sustainable throughput.

Yet other objects are achieved by providing a computer-implemented method of comparing resource usage including the steps of executing software on a processor of a system computer and receiving a comparison request via the software, the comparison request including a selection indicative of a group selection and at least one criteria. The processor may access the storage to retrieve the relevant data for comparison. The method may further include accessing first company data from the at least one storage, the company data relating to the criteria of the first company. The criteria may be, for example, one or more telecommunications criteria. The method may also include accessing group data from the at least one storage. The group data may relate to the criteria of the at least one group of one or more entities. The method further includes software executing on the processor for comparing the company data to the group data and generating a metric based on the comparison. The metric is then accessible by the user computer. It should be understood that although a particular order may be described, the steps of the method may be arranged in a different order.

The system or method may further include providing an interface, such as for example, a graphic user interface (GUI). The interface may be provided by software executing on the system computer or software executing on a user computer in communication with the system computer. The method may further include receiving a plurality of selections via the interface, the plurality of selections received from the user computer and including a group selection and a criteria selection where the software executing on the system computer generates the comparison request.

The method may further include generating a range of service levels from performance data associated with the first company data, the performance data indicative of telecommunications service performance. The method also includes receiving group data having performance data associated therewith according to the range of service levels for comparison of group data to first company data within the range of service levels.

The terms “first” and “second” are used to distinguish one element, set, data, object or thing from another, and are not used to designate relative position or arrangement in time.

The terms “communication”, “communication with”, “coupled”, “coupled to”, “coupled with”, “connected”, “connected to”, and “connected with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

The term “telecommunication services criteria data” represents the data used in performing a calculation according to one or more selected criteria relating to telecommunications services. The telecommunication services criteria data may be calculated or un-calculated and may include a number of different data points that are used with the criteria. For example, calculated data in the example of directory assistance charges would mean that a simple number charged would be returned, such as cost for directory assistance associated with a particular month or other period. Un-calculated data may be the data associated with the particular charges where the system accesses the storage to determine all directory assistance charges and the system then calculates the total for use in calculating the criteria associated with the particular telecommunications services criteria data. The example of directory assistance charges used herein is only provided as an example and should not be seen as limiting.

“Telecommunications service data” may include, for example, (1) usage data indicative of telecommunications usage for the telecommunications service; (2) expense data indicative of telecommunications expense for the telecommunications service; and (3) performance data indicative of telecommunications service performance. Examples of some telecommunications criteria are shown in Table 1 below. It should be understood that similar terms such as “utility services criteria data” would mean similar data, but applied to utility services, such as gas, oil or electric. Services other than “utility” can be used in connection with “services criteria data” to define similar data used in calculating the various criteria for comparison across different resources.

As used herein, the term “profile” is used to designate usage, expense and/or performance of a resource. For example, a “telecommunications profile” would represent a telecommunications usage, a telecommunications expense, or a telecommunications performance, and/or combinations thereof. Each profile could be associated with, for example, a company or entity. The system described herein may provide a number of metrics to one company that allows them to compare their resource usage, a telecommunications expense and/or telecommunications performance for a number of different criteria. These metrics may allow the company to determine how their profile compares to a profile of a group or a profile of another company or group of companies.

### BRIEF DESCRIPTION OF THE DRAWINGS

FIG. 1A is a block diagram of the present invention.

FIG. 1B is a block diagram of an alternate embodiment of the invention shown in FIG. 1A.

FIG. 2 is a flow chart according to the system of FIGS. 1A and 1B.

FIG. 3 is a flow chart as referenced in FIG. 2.

FIG. 4 is an exemplary embodiment of a general module of the system shown in FIGS. 1A and 1B.

FIG. 5 is an exemplary embodiment of a group selection module of FIGS. 1A and 1B.

FIG. 6 is an exemplary embodiment of a resource selection module of FIGS. 1A and 1B.

FIG. 7 is an exemplary embodiment of a category selection module of FIGS. 1A and 1B.

FIG. 8 is an exemplary embodiment of FIGS. 1A and 1B.

### DETAILED DESCRIPTION OF THE INVENTION

An aspect of the system allows companies, organizations and various entities to compare themselves to groups of similar companies. Among other metrics, the system allows the first company to compare their expenditures on various resources. The comparison may be done according to a user selected group that can identify a number of settings. Some settings include, but are not limited to company size, revenue, expenditure levels or ranges for particular resources such as service ranges, number of employees and number of locations. The settings may also be based on geographic location. The system takes usage, expense and performance data from various sources across multiple entities to provide, for example, a score or comparison metric or chart.

The metric returned may be, for example, in the range of 1-10, and this score would depend on how the calculation of the criteria for the first company compares to the group. The score may be a ranking, or the score may be associated with a particular percentile. As an example, if there are 9 companies in the group and the company has the third best score for a particular criteria, this company would get a value of 8, the top company would receive a 10 and so forth. If there are three companies in the group, the best company may receive 10, the 2^{nd} company may receive 7 and so forth. The values for the particular company viewing the report or metric may be displayed as a bar graph, chart or other. The system can calculate the selected criteria for each of the companies, and using these calculations, the ranking of the company viewing the report may be calculated. It is also contemplated that the values calculated through the criteria may be displayed as metrics. For example, if there are 9 companies in the group, the values calculated for each company according to each of the criteria could be displayed with their associated values as a metric. It is possible that a company may rank last out of the companies for a particular criteria, but if the actual value is very close, it may be more expensive to try to improve the ranking than worth the cost associated with doing so.

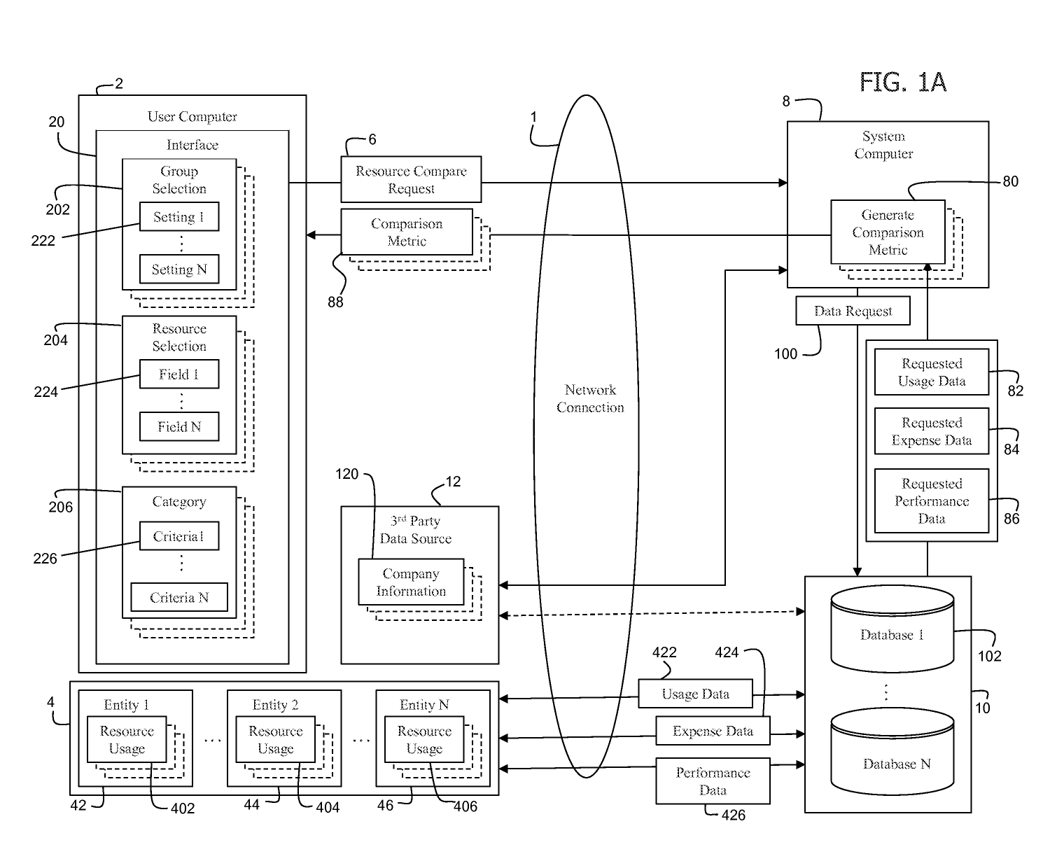

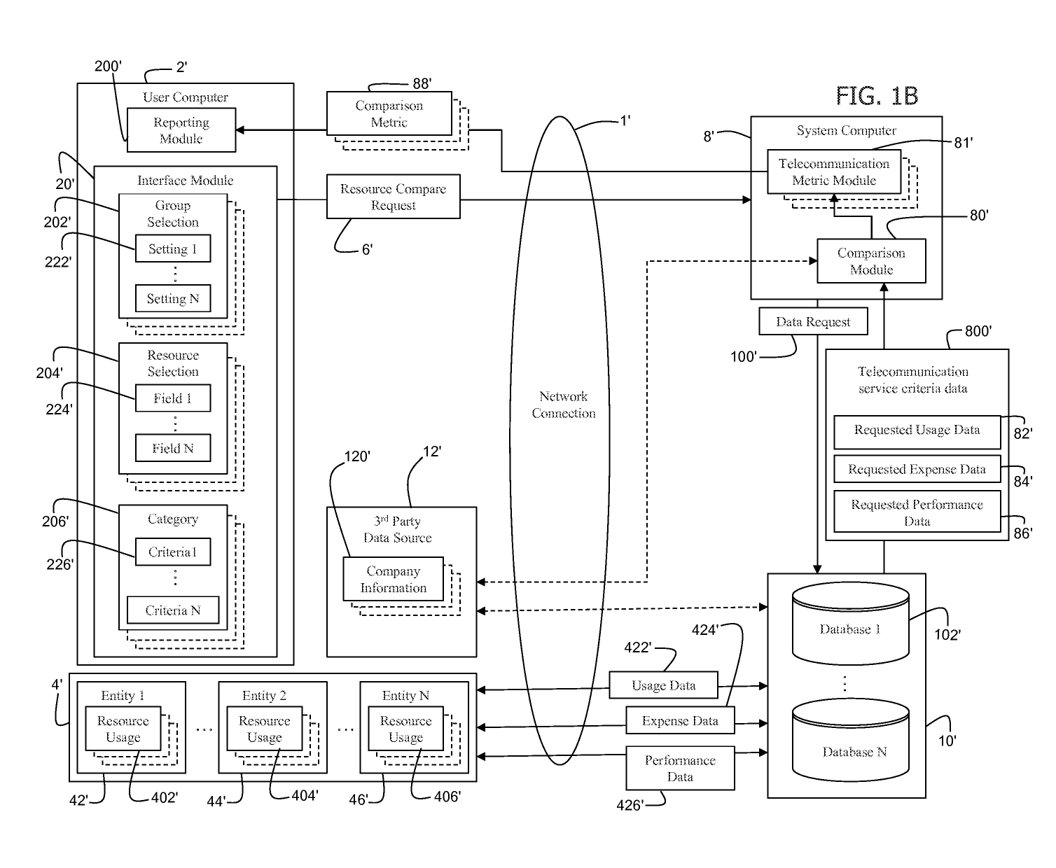

In FIG. 1A, a first company with a client computer 2 is connected over a network connection 1 to a system computer 8. The network can be an Internet, Ethernet, LAN, wireless, telephone, satellite or other. Data about the first company's resource usage, performance, and expenditures may be stored on the database. This data can be used to compare the first company to the group, alternatively, the database and/or system computer can receive data required to compare the first company to the group. Data can be received from a number of locations, such as the entity computers, data centers, databases, cloud computing databases, third party data sources and the like. The data may also come from the user or client computer, database, cloud computing database, third party source and the like. The first company may wish to compare various resource usage, expenditures or performance metrics across one or multiple companies to determine how their resource usage, expenditures or performance metrics compare within the industry or with groups of companies meeting similar criteria. This allows the first company to determine where they stand relative to other companies meeting the selected criteria. The first company may then determine if they should spend more or less on a given resource or if they should adjust the performance of a resource. A number of other comparisons are contemplated within the system.

Both of the client computer 2 and system computer 8 may include processors with software executing thereon. The software of the client computer may provide an interface 20 with a number of modules. The software may also provide the interface through a web browser, or the software may reside on the system computer, or server connected to the system computer. The system computer may also be a web server that is accessible by the user computer using a login or another security feature, for example, a secure or encrypted connection. A group selection module 202 allows the entity to select one or more settings 222 to use to compare themselves to other entities. These settings 222 can include, for example, sector, industry, revenue size, size of resource spend, number of locations, geographic location, number of employees. Additional settings are contemplated and may depend on industry. There is also a resource selection module 204 and a category selection module 206. The resource selection module allows the first company to select from one or more fields 224. The category selection module allows for the selection of criteria 226.

The fields may designate different resources. For example, telecommunications, oil, gas, electric, human resources, insurance, supplies, and raw materials and the like. Third party data can also include information relevant to various resources. For example, oil, gas and electric may be dependent on the weather, for example, temperature. Additionally the system may monitor temperature in various rooms or locations and compare these temperatures to external temperatures to compare temperature drops due to weather and the amounts of resources required to heat or cool a particular location. Human resources may compare expenditures such as salary and benefits and comparisons may be done across other companies by position, number of years employed etc. The selection of insurance resources may compare policy coverage levels to premiums and deductibles and various other limits and terms of the insurance policy or contract.

As shown, the resource, group and category selection modules are discrete parts of the interface. It is possible depending on what information is being compared that the category selection module 206 is part of the resource selection module 204. For example, if specific categories are only relevant to particular resources, a specific category selection module for the specific resource may be warranted. In other words, selection of a particular resource module 204 can affect what selections are presented in the category selection module 206. Other combinations and sub combinations of the modules are contemplated, and the above example should not be seen as limiting.

The category selection module may include one or more criteria 226 to use to compare the first company to other companies according to the group selection. Some examples of these criteria as related to telecommunications are shown in the chart below, however other criteria may be used to generate other metrics, and it is contemplated that the interface may allow for customized criteria and metrics to be generated based on user selection, industry, company size or other.

The system computer 8 may receive a resource compare request 6 from the client computer 2. The resource compare request may include the various settings 222, fields 224 and criteria 226 selected through the interface 20. The resource compare request 6 may be inputted or selected through the interface according to the modules or software previously described. The system computer may request the required data from one or more databases 10 using a data request 100. It is also contemplated that the system computer may access the storage to read and or use the required data. In generating the data request 100, the system computer compares the resource compare request 6 with the data available in the database(s) 10, and data available from third party data sources 12. In some cases, the data may require updating to provide current or up to date information on the companies or entities within the selected group. Although shown in the figure as being between the system computer and database, it should be understood that the data request 100 may be sent to the third party data source 12 or any of the entity computers, database, cloud computing databases and the like. The data request may further include a request for updated or new data for use in comparison, where the new or updated data can be sent to the storage and/or to the system computer.

As referenced above, some of the data used in comparison may come from a 3^{rd} party data source 12. This could include information relevant to the group selection module such as company information 120. Company information may include for example, company size, number of employees, revenue and other information relevant to generating a comparison metric or defining the group. If appropriate, a data request to the 3^{rd} party data source 12 can be generated by the system computer. The request may also be transmitted through the database. Optionally, the data request may originate with the comparison request. The database can store the relevant 3^{rd} party data. Other third party data can include, for example, weather patterns, commodity prices such as oil prices, gas prices, electricity rates, and other commodity prices that may be relevant for comparison. Third party data can also include securities prices and associated securities data for comparison, this may include market capitalization, earnings information and other data or information about a security or other financial product. It is understood that a request may be the system computer accessing the storage or database, alternately, the system computer may access the storage or database without using a request.

The system computer 8 may also generate the data request on the basis of the resource compare request 6. Alternately, the data request may be contained within the resource compare request 6 and the system computer transmits the data request to the database(s) 10.

The databases may be on site or off site. Although not shown, the database could be one or more cloud computing databases that are available to the system computer 8, or database(s) 10 or user computer 2 over a network connection. Each database may be associated with a particular entity or a particular type of data. Alternately, one database could include all the necessary data for performing a variety of comparisons. It is contemplated that the database(s) 10 may be replicated or backed up on separate databases; it is further contemplated that databases can be positioned in different geographic locations. This may aid to reduce transfer times or rates or to comply with varying privacy or security concerns, laws or standards. Although shown as a database, the storage may encompass numerous types of computer accessible or computer based storage. For example, flash memory, hard disks, magnetic storage, compact discs, floppy discs, and internal or external hard drives and the like.

The database(s) 10 receive data from one or more entities 4. Each entity 42, 44, 46 etc. has a corresponding resource usage 402, 404, 406 and data associated therewith. The data can come from the entities 4 and can also include contract data indicative of contracted rates and performances or service levels of the entities or company so that both actual performance and contracted performance can be used to generate metrics. The contract data could also include various other contracted rates and limitations relevant to the resource. This can include rates paid for telecommunications, utilities or other contract rates such as insurance premiums, deductible, limits, exclusions etc. It is also understood that the company that is generating the comparison could also be included in the entities 4 so that data relevant to the company's resource usage, expenses, performances and/or service levels are included for comparison. The data may include types of data required for comparison according to various available criteria that have been described herein. Each entity may also have one or more resources used, and all of this data can be received by the database(s). For example usage data 244, expense data 424 and performance data 426. Each of the usage, expense and performance data can be associated with a number of fields, resources or other information to be used for comparison. The performance data could be based on actual or approximated performance, and the performance data could also be based on service levels. Company information may be delivered from a 3^{rd} party data source or directly through the entity. The system computer 8 may then receive the requested usage 82, expense 84 and performance 86 data according to a data request 100. The system computer 8 may generate one or more comparison metric(s) 80 using this data, and the client computer receives the comparison metric(s) 88. The comparison metric(s) 88 may be displayed on the client computer. The interface 20 may include a preview area showing the metric. These metrics can be used in generating a chart. The chart can be generated by either the client computer upon receipt of the comparison metric(s) 88. Alternatively, the system computer 8 can generate the charts while generating the comparison metrics 88.

Customers can select from available criteria and can define their group through the group selection module. The group selection allows a comparison to entities or organizations by a number of settings. These settings can include, for example: sector, industry, revenue size, size of resource spend, number of locations and number of employees. Size of resource spend would depend on the resource. For example, if a particular industry or company has a high spend on electricity for manufacturing purposes, the group selection may be adjusted to compare a particular resource. The group selections can all have sub categories to further define the group, allowing the Company to compare with entities or companies that are most relevant. Other group settings may compare usage based on active hours in a day. For example, if one factory runs 24 hours a day and another factory runs 12 hours a day, the rate of resource usage would likewise be expected to be different. The system may be designed to extrapolate usage so that the companies with different active hours per day may be compared, alternately, the system may only compare companies within a similar range of active hours in a day. Similar extrapolations can be used with other company data, for example, revenue. If one company has revenue of $5 million and the group includes a number of companies with revenue of $10 million, the data used in calculation according to the criteria may require extrapolation to account for revenue differences, for example, it would be expected that a company with $10 million in revenue would spend more on telecommunication services than a company with $5 million in revenue. The comparison module described herein could perform the extrapolation where required.

In FIG. 1B, the system computer 8′ is shown with a telecommunication metric module 81′ and a comparison module 80′. The comparison module compares the telecommunication service criteria data 800′ and the telecommunication metric module 81′ generated a comparison metric 88′ that is sent to a reporting module 200′. The metric may be, for example, a graph, percentile ranking, or chart. Telecommunication service criteria data can include, for example, that data required to generate the comparison according to the criteria. In the example of % Directory assistance, data included for that criteria would include at least the total charges for Directory assistance and the total telecommunication expenses. The data may be compiled or calculated already, meaning that if the company spent $1,000 on directory charges, the data relative to directory charges could simply be the value 1000. Alternately, the data received can be uncalculated or computed, for example, the system would search or query the database for all directory assistance charges to calculate the total.

The user computer 2′ has an interface module 20′ that can have multiple sub modules such as group selection module 202′, resource selection module 204′ and category module 206′. These modules of the interface module 20′ are used to generate a comparison request 6′. The modules 202′, 204′, 206′ allow for selection of settings 222′, fields 224′ and criteria 226′ similar to those shown and described in reference to FIG. 1A. It is understood that the various modules may be combined together in various combinations. Many of the remaining elements shown in FIG. 1B are similar to those shown and described previously with reference to FIG. 1A. For example, network connection 1′ is similar to network connection 1.

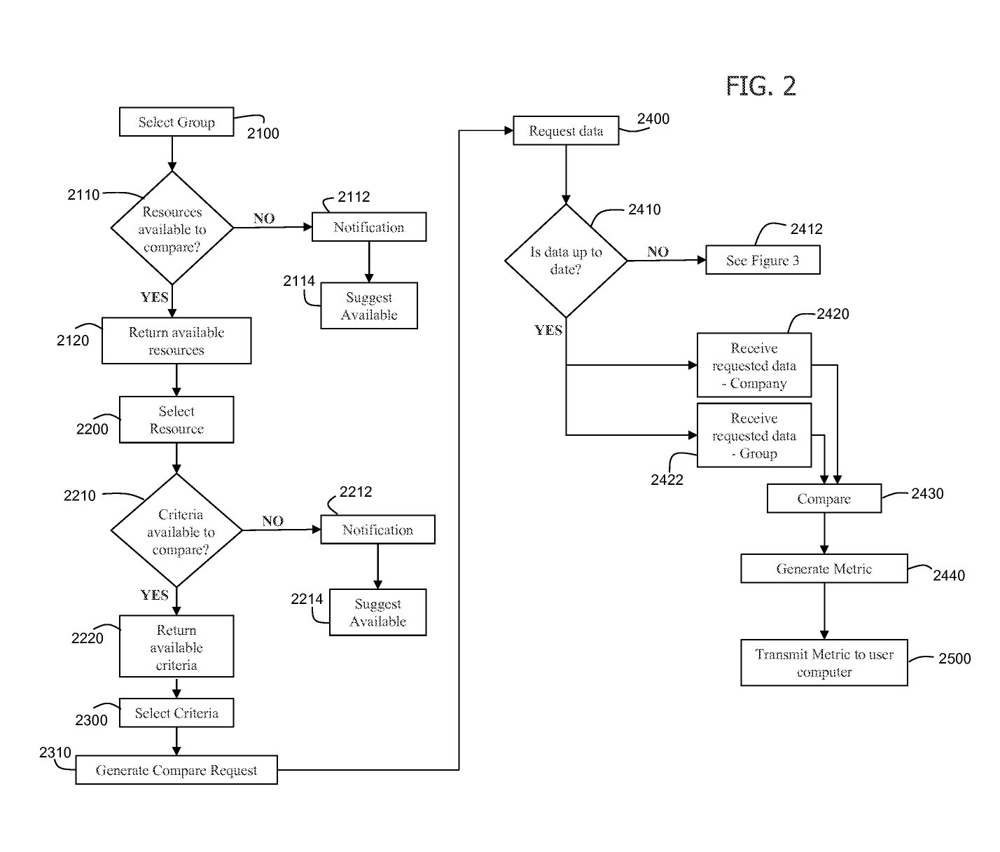

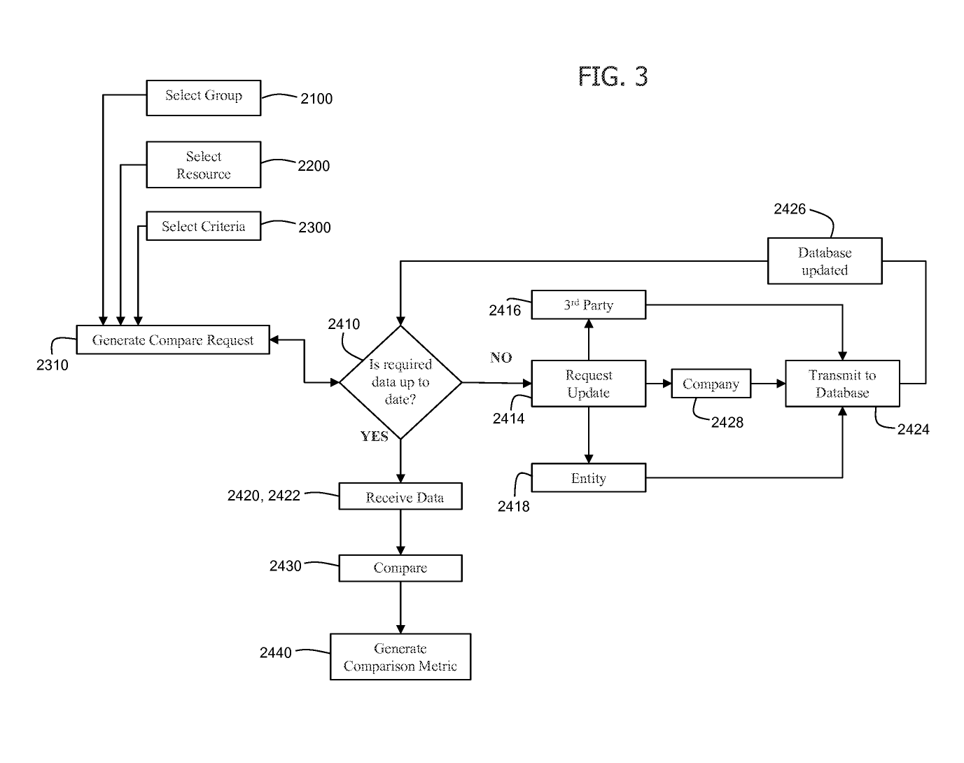

FIG. 2 shows the method of the present invention where a group is selected 2100 and the system determines if resources are available to compare 2110. For example, the system may query the database to determine if sufficient data exists to generate comparison metrics. If there is insufficient data, the system may query various data resources, such as 3^{rd} party data sources, user and client computers or servers or databases and the like. If there is not enough data for comparison, the user is notified 2112 with suggested group selections 2114, alternately, the interface may make certain setting 222, field 224 and criteria 226 selections unavailable, depending on the company, resource and/or category available. When resources are available to compare, the available resources are returned 2120 and the system allows for a resource selection 2200. If there are no criteria available to compare, a notification is sent 2212 and available criteria 2214 are suggested. Available criteria 2220 are returned and the system allows for the selection of criteria 2300 based on the availability of data for comparison. Using the selections 2100, 2200 and 2300, the system generates a compare request 2310. The comparison request will be used to compare required data of the company to the group of the company, and therefore, the system requests the required data 2400. This may include a data request 100 that has previously been described. The data may exist in the database or a storage, or optionally, the system may need to request an update of the data from a specific database, and/or a third party source. The database updating process is shown in more detail in FIG. 3.

If the data is up to date, the software receives the requested company data 2420 and the requested group data 2422. The software compares 2430 the data 2420; 2422 and generates a metric 2440. The metric is then transmitted to the user computer 2500.

FIG. 3 shows how comparison data is updated when necessary. When an update is necessary, the software may request an update 2414 from an entity 2418, a third party 2416 and/or a company 2428. The data update is transmitted to the database 2424, and the database is updated 2426. The data is received 2420, 2422 and compared 2430 to generate a comparison metric 2440.

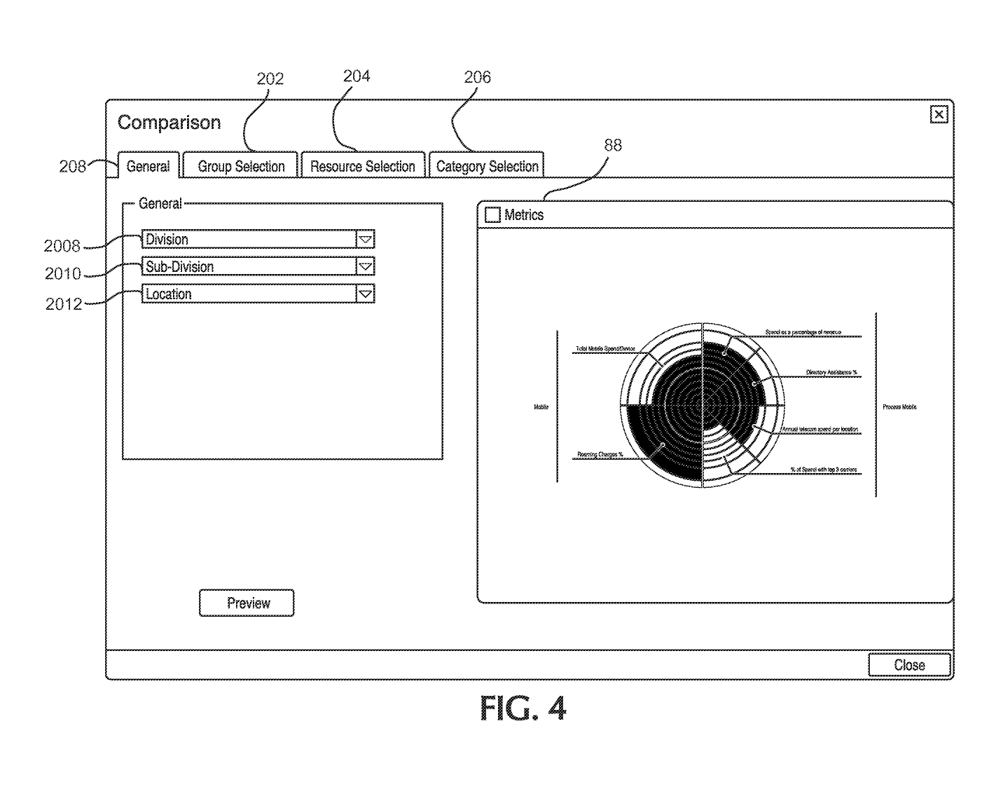

FIG. 4 shows a general module 208 of the interface 20. If the company has multiple divisions, sub-divisions or locations and wishes to only compare the performance of specific sections of the company to other companies, the general selection module allows the company to define the part of the company to compare. The general module 208 may provide drop down menus for division 2008, sub-division 2010 and location 2012. The separate divisions and sub-divisions can be within the same company, or they can select based on a company that controls multiple entities where the company wishes to compare a specific entity or division that is under the control of the broader company. It is understood that the interface may include a number of ways for framing the desired comparison. Drop down menus, and check boxes are shown, however it would be understood that sliding graphical bars to provide customized ranges may be used. It is also understood that customized ranges may be inputted manually by typing for a customized range or parameter. Optionally, criteria can be generated through structuring various data queries, calculations or formula to create a custom criteria/metric. Criteria may also exist that compare across different resources. For example, a comparison metric between heating expenses (such as gas, oil, electric) and telecommunication expenses may be generated through customized criteria where a number of data points are available for selection, and these data points can be plugged into a user generated formula. These data points would be considered part of the criteria data. If the data point is related to telecommunications services, the data point would be considered part of the telecommunication services criteria data. As an example only, a data point may be total expenditures on directory assistance, another data point may be total expenditures on electricity, and the interface could allow for the generation of a metric based on a custom criteria that calculates directory assistance/electricity expenditures. This is seen as an example only, and should not be limiting, because multiple data points can be used to create different customized criteria, metrics and reports. Different mathematical calculations such as multiplication, division, square roots and other calculations may be used for creating custom criteria. Multiple data points can be used for the custom criteria as well. It is understood that the interface may be provided to allow for building, creating and customizing criteria, metrics and/or reports.

It is also contemplated that the system may be set to automatically generate comparison metrics on a regular or pre-set basis. For example, the system could be configured to run a certain comparison based on criteria, fields and settings selected through the interface. The interface would allow for selection of a recurrence of the particular report or comparison. For example, monthly reports may be generated, and the results can automatically populate graphs based on pre-configured reports. For example, if a company wishes to track certain metrics on a monthly basis, these metrics may be reported on the monthly basis and the metrics may also be reported on a chart that shows, for example, the trend over the last 12 months, and how the metric has changed. Different trends could be overlaid on the same graph so that the company can determine how they compare to trends over a longer period. It is also contemplated that the database can be queried on a historical basis to generate charts, reports and trends for past activity.

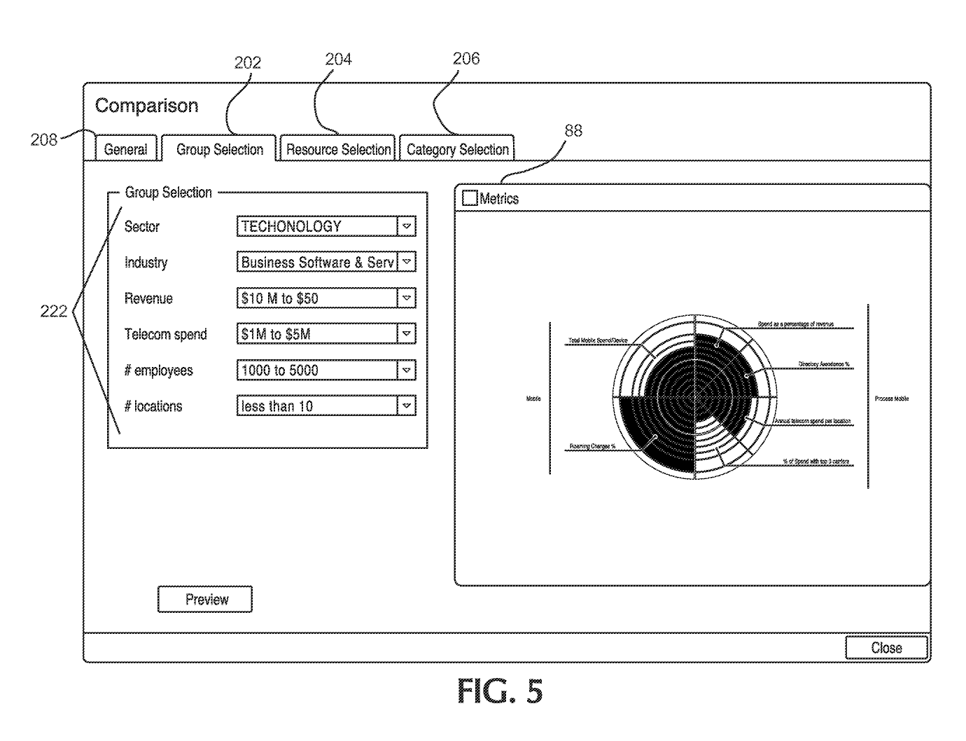

FIG. 5 shows an example of the group selection module 202 of interface 20. Also shown are general 208, resource selection 204 and category selection 206 tabs which are shown by separate figures. Each of the modules may be provided by software, and the software may execute on a user computer or on the system computer. The group selection module 202 and other interfaces and modules may be accessible through locally installed software, and the interfaces may also be accessible through internet browsers or other web based interfaces. The settings 222 become part of the comparison request that allows for the comparison between the first company and the group of companies. The group selection allows for the selection of a number of settings 222 that define the scope of the group for comparison. When the interface is opened, the system can default to suggested settings, optionally, a button or selection may be included to revert to defaults. The defaults may vary depending on the various settings associated with the company. The defaults can change automatically, for example, when the number of employees of the company increases, the different settings may need to change so that the companies in the group are of similar sizes. Defaults may be automatically determined, or the interface may allow for customized defaults either based on a pattern detected by the metrics or reports generated or based on user selected custom settings. It is also contemplated that the settings can be selected so that the range of revenues compared is updated based on the company's data. For example, the setting related to revenue could be +/−$2 million from the company's revenue. So that if the company's revenue is $5 million, the range would be $3-7 million. If the company made more money the next year (or other period), and their revenue grew, the range would adjust accordingly. The range could be specific number or percentage based. As acquisitions happen, the company sector may change, therefore, the system is able to run the comparison across the entire company or across specific divisions or specific sectors. Data used in comparison could be associated with the division or sectors. It is also possible that all divisions may be compared on a report, metric or chart as necessary. The interface and interface modules would provide for appropriate selections.

Some of the interfaces are shown with drop down menu bars that when clicked or selected would show a list of possible settings. Where appropriate, there can also be an option to adjust the pre-defined list of settings to include more narrow ranges. The suggested settings would be defined based on the characteristics of the company, and would be updated as the company grows, contracts or shifts sectors. As shown in FIG. 5, the defaults for the particular company initiating the comparison are a sector of technology, an industry of business software and services, revenue of $10-50 million, telecommunication spending of $1-5 million, 1000-5000 employees and less than ten locations. As previously described, custom settings may be used. For example if a company has 2000 employees, a range of 1000-5000 may be too broad, and it may be more advantageous to have a custom range of 1000-3000. Other customized settings are contemplated within the scope of the system. Also shown are a number of tabs 208, 204, 206, 202 that are associated with separate modules.

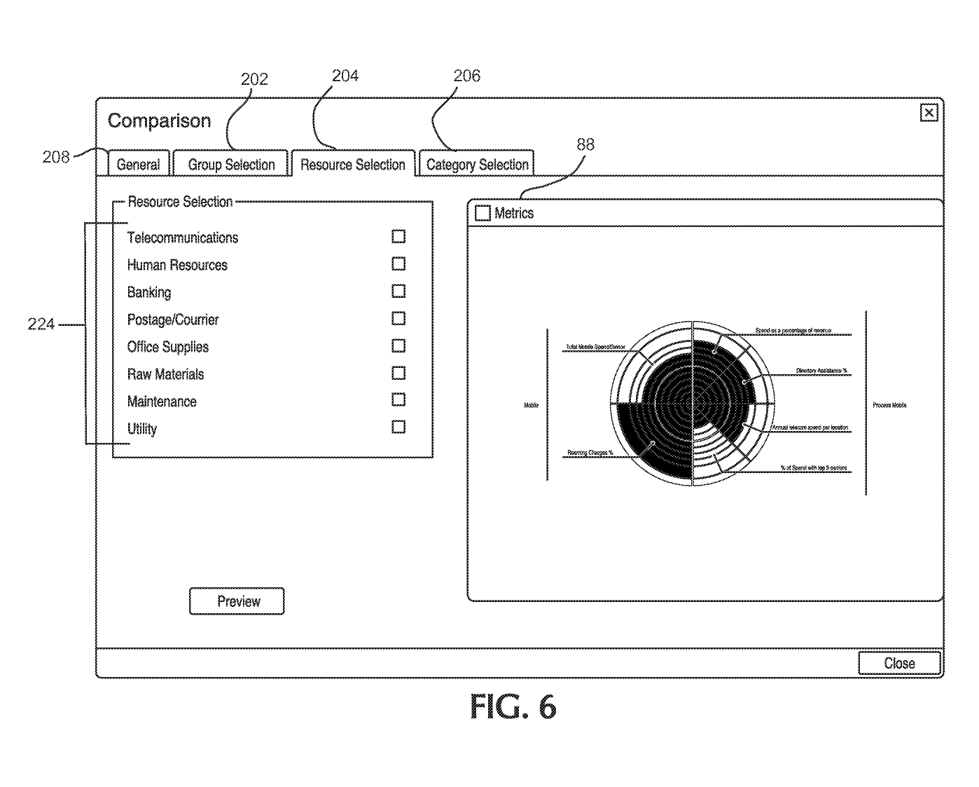

FIG. 6 shows the resource selection module 204 of the interface. A list of fields 224 are selectable using a check box 2240 that is associated with each field 224. As shown, there are telecommunications, human resources, banking, postage/courier, office supplies, raw materials, maintenance, and utility fields. These fields are exemplary only and should not be seen as limiting. Each field has a number of criteria associated with it, and these criteria are selected through a category selection module 206. Telecommunications has number of criteria that are more fully explained in the table below. Human resources can be associated with various data indicators for comparison. For example, insurance payments, compensation, benefits, employment term, employee age and education as well as other indicators relative to employee performance can be the basis for comparison. It is understood that employee performance indicators would depend on industry. In the example of a salesperson, percentage of sales leads one could be one example of a performance indicator. A company may also wish to compare their health insurance expenditures per employee to a group of companies of similar size. Upon generating the metrics, a chart may show metrics generated from multiple criteria. This could allow a company facing difficulty retaining employees to compare the employment term to benefits, compensation or other metrics using the chart to determine how to retain employees more effectively. Other resources such as banking, postage/courier, office supplies, raw materials, maintenance, and utility fields would each have criteria and data associated therewith for comparison in order to generate relevant metrics.

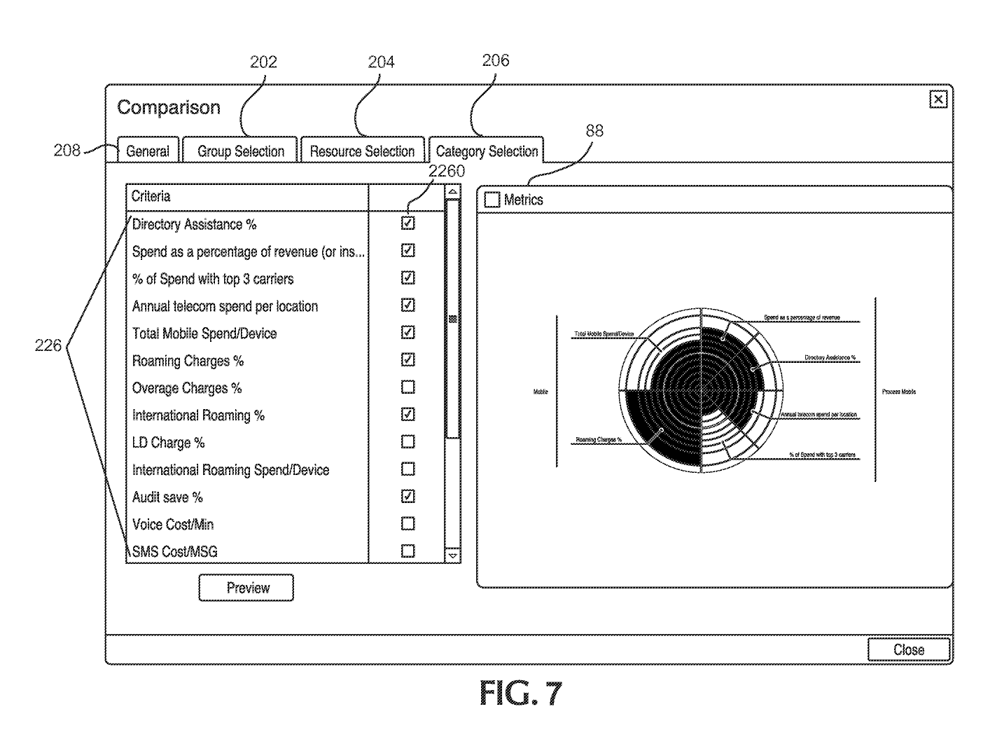

FIG. 7 shows the category selection module 206 of the interface. Criteria 226 are displayed based on the group and resource selections and the availability of data to compare. The criteria are selectable using check boxes 2260. Although check boxes are shown, it would be understood that other ways of selecting criteria, settings or fields in the interface may be used. As shown in FIG. 7, the criteria displayed are related to telecommunications. The criteria selections become part of the comparison request for generating the metric. Examples of criteria shown include Directory Assistance %, Spend as a percentage of revenue, % of Spend with top 3 carriers, Annual telecom spend per location, Total Mobile Spend per device. Roaming Charges, Overage charges %, International Roaming % Long Distance charge % international roaming spend per device, audit save %, voice cost per minute and SMS cost per message are all possible criteria. It is possible to configure the interface to only show available comparison criteria based on the available data. Also the interface may highlight selected criteria or shade the non-selected criteria to be less visible.

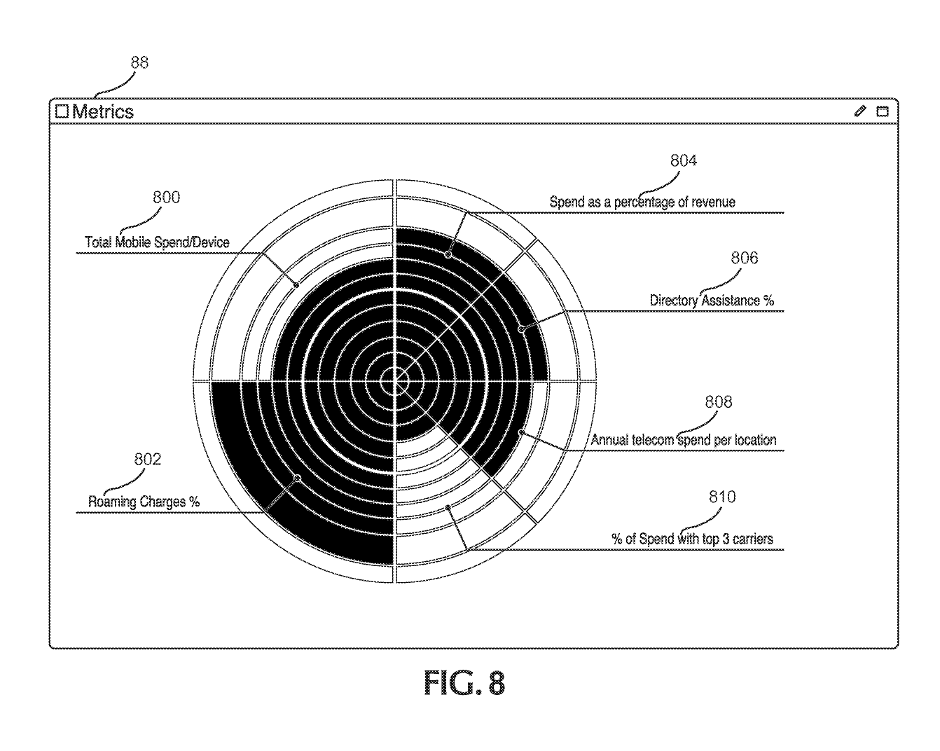

FIG. 8 shows an example of a chart generated by the system. As previously described, the system computer or the client computer can generate the chart on the basis of the one or more comparison metrics 88. Examples of metrics shown according to the criteria 226 are Total Mobile Spend/Device 800, Roaming Charges % 802, % of spend with 3 top carriers 810, annual telecom spend per location 808, directory assistance % 806 and spend as a percentage of revenue 804. These are all possible comparison metrics, however, other metrics and types of charts are contemplated within the system. The chart shows a number of bars having a value. For example 1-10. 10 being the best 1 being the worst. It is possible that there is not enough data or the metrics are not available and a value of zero may be returned, or the system could eliminate the particular metric from the chart altogether. The graph may be configured so that the values are reversed for consistency. That is, it would be desirable to minimize roaming charges, because these are typically expensive. So, if a company had very small roaming charges, instead of the graph showing a bar close to center (which could be a bad indicator), the bar would be shown as high value ie 10. Although the chart is shown as a circular bar graph, other charts are contemplated. It is also possible to give percentile rankings instead of the charts. The metrics shown and discussed herein are exemplary only and should not be seen as limiting.

The system may also be capable of analyzing the sales pipeline to compare a company's sales pipeline within the user selected groups of companies. Although not shown in the figure, the sales data can come from the entity or the 3^{rd} party, depending on where the data is. The system may compare percent of leads converted to sales, time from contact to conversion or a number of other comparisons that could be helpful in analyzing or grading sales performance. Similar comparisons can be done for customer service and tech support.

The following table shows a number of criteria related to telecommunications. Also shown is how the system computer performs the calculation based on the first company and group data to generate the metric. The criteria are examples and are not limiting.

| | | | Best Case Result | | |
|---|---|---|---|---|---|
| Criteria | Category | Calculation | (10 score) | Parameters | Note |
| Directory | Fixed | =(Sum of all | Lowest values | Date Range | |
| Assistance % | and | DA charges)/ | No directory | (Last qtr) | |
| | Mobile | (Total Spend) | assistance | | |
| | | | charges would be | | |
| | | | the best case. | | |
| Spend as a | Fixed | =(Total | Lowest values | Date Range | |
| percentage of | and | telecom | Low expenses | (Last qtr) | |
| revenue (or | Mobile | spend)/ | when compared to | | |
| instead of revenue | | (Total | sales is better. | | |
| use SG&A - Sales, | | revenue) | | | |
| General & | | | | | |
| Administrative | | | | | |
| costs) | | | | | |
| % of Spend with | Fixed | =(Total | Highest values | Date Range | Carrier |
| top 3 carriers | and | spend at top | A high percent of | (Last qtr) | concentration |
| | Mobile | 3 carriers)/ | spend w/top 3 | | |
| | | (total | carriers means | | |
| | | telecom | that all of the | | |
| | | spend) | spend is | | |
| | | | consolidated, This | | |
| | | | should result in | | |
| | | | better ability to | | |
| | | | negotiate | | |
| Annual telecom | Fixed | =(total | Lowest values | Date Range | |
| spend per location | and | spend)/(# | The less spent at | (Last qtr) | |
| | Mobile | locations) | each location is | | |
| | | | better. | | |
| Total Mobile | Mobile | =(total | Lowest values | Date Range | |
| Spend/Device | | spend)/(# | | (Last qtr) | |
| | | mobile | | | |
| | | devices) | | | |
| Roaming Charges % | Mobile | =(total | Lowest values | Date Range | Divide by |
| | | roaming $)/ | | (Last qtr) | total telecom |
| | | (total | | | or total |
| | | wireless | | | wireless |
| | | cost) | | | |
| Overage Charges % | Mobile | =(total | Lowest values | Date Range | Divide by |
| | | overage $)/ | | (Last qtr) | total telecom |
| | | (total | | | or total |
| | | wireless | | | wireless |
| | | cost) | | | |
| International | Mobile | =(total intl | Lowest values | | Divide by |
| Roaming % | | roaming $)/ | | | total telecom |
| | | (total | | | or total |
| | | wireless | | | wireless |
| | | cost) | | | |
| LD Charge % | Mobile | =(total | Lowest values | | Divide by |
| | | wireless Id | | | total telecom |
| | | $)/(total | | | or total |
| | | wireless | | | wireless |
| | | cost) | | | |
| International | Mobile | =(total intl | Lowest values | | |
| Roaming | | roaming $)/ | | | |
| Spend/Device | | (# wireless | | | |
| | | devices) | | | |
| Audit save % | Audit | =(Realized | Highest values | | |
| | | savings)/ | Higher numbers | | |
| | | (Telecom | indicate a greater | | |
| | | spend) | percentage of | | |
| | | | telecommunication | | |
| | | | spend is saved by | | |
| | | | audits. | | |
| Audit win % | Audit | =(# | | | |
| | | Customer | | | |
| | | accepted | | | |
| | | saving | | | |
| | | finds)/(# | | | |
| | | Vendor | | | |
| | | accepted | | | |
| | | saving | | | |
| | | finds) | | | |
| Voice Cost/Min | Fixed | =(total | Lowest values | | |
| | and | voice | | | |
| | Mobile | spend)/(total | | | |
| | | # of | | | |
| | | minutes) | | | |
| SMS Cost/Msg | Mobile | =(total SMS | Lowest values | | |
| | | cost)/(total # | | | |
| | | of message) | | | |
| Data Cost Per MB | Mobile | =(total data | Lowest values | | |
| | | spend)/(total | | | |
| | | data used) | | | |
| Data Cost/Device | Mobile | =(total data | Lowest values | | |
| | | cost)/(# of | | | |
| | | devices) | | | |
| Voice Cost/Device | Mobile | =(total | Lowest values | | |
| | | voice | | | |
| | | cost)/(# of | | | |
| | | devices) | | | |
| SMS Cost/Device | Mobile | =(total SMS | Lowest values | | |
| | | cost)/(# of | | | |
| | | devices) | | | |
| Equipment | Mobile | =(total | Lowest values | | |
| Cost/Device | | equipment | | | |
| | | cost)/(# of | | | |
| | | devices) | | | |
| FOC Date | Fixed | =(# orders | Highest values | | FOC = Firm |
| Success % | | meeting | A larger value | | Order |
| | | commitment | indicates that the | | Commitment |
| | | date)/(# | company is having | | |
| | | orders | good success with | | |
| | | having a | vendors meeting | | |
| | | FOC date) | their commitment | | |
| | | | dates. | | |
| Total Capacity for | Fixed | | | | |
| Access | | | | | |
| Liability Make-up | Mobile | | | | How does |
| (CL/IL/Hy/Combo) | | | | | liability profile |
| % | | | | | compare to |
| | | | | | world |
| Liability Profile | Mobile | | | | Liability |
| relationship to | | | | | profile |
| revenue | | | | | efficiency - |
| | | | | | revenue |
| Liability Profile | Mobile | | | | Liability |
| relationship to cost | | | | | profile |
| | | | | | effectiveness - |
| | | | | | cost |
| Mobility | Mobile | | | | # mobile |
| Penetration % | | | | | devices/# |
| | | | | | eligible |
| | | | | | employees |
| Device/ Mobile | Mobile | | | | % of devices |
| OS concentration | | | | | by OS, type, |
| | | | | | etc. |
| Avg age of mobile | Mobile | =(sum of | | | Technology |
| device | | ages of | | | obsolesce |
| | | device)/(# of | | | |
| | | devices) | | | |
| 1-10 & 13-19 | Mobile | | | | |
| above avg by | | | | | |
| employee | | | | | |
| Spend profile | Fixed | | | | Compares |
| quotient | and | | | | spend mix |
| | Mobile | | | | between like |
| | | | | | companies |
| Liability Profile | Mobile | | | | Benefits |
| Migration | | | | | achieved by |
| | | | | | switching |
| | | | | | liability |
| Policy/Governance | Mobile | | | | Comparison |
| Depth | | | | | of # of mobile |
| | | | | | policies |
| Business apps per | Mobile | =(sum of | | | Penetration |
| device/employee | | business | | | of business |
| | | apps)/(# of | | | apps - |
| | | employees) | | | employee |
| | | Or | | | efficiency |
| | | =(sum of | | | |
| | | business | | | |
| | | apps)/(# of | | | |
| | | devices) | | | |

The criteria referenced in the above chart and other criteria described herein are used to generate a metric. The above criteria are exemplary only and should not be seen as limiting. The metric may be similar to the chart shown in FIG. 8, or the metric can be a percentile ranking, score or other visual, numeric, audible or other type of indicator that would show how a company (or division thereof) compares to the group according to the selected criteria.

It is further contemplated that one chart can display multiple criteria relative to multiple resources. For example, if two resources are selected through the resource selection module, the criteria available can include criteria relative to each selected resource. The chart displayed can then include metrics for all of the selected criteria. The system can also include suggested or default resource, group and category selections for standard charts or metrics that are most commonly used. Alternately, the system can store a customized chart or chart preferences so that the comparison can be run in a repeatable fashion in order to show progress. It is also contemplated that the system can be set to automatically generate charts or metrics on the basis of a defined comparison request that is repeated automatically at selected time periods or other types of intervals.

What is claimed is:

1. A system for comparing a telecommunications resource of a first company to a telecommunications resource of at least a second company, the system comprising:
a system computer having a network connection;
a storage accessible by said system computer;
an interface module associated with said system computer allowing a user associated with the first company to access said system computer with a user computer;
a comparison module associated with said system computer receiving a comparison request from the user computer, the comparison request including a group selection that includes at least the second company, and a criteria selection that includes telecommunications services criteria associated with a telecommunication for both the first and second company;
said comparison module comparing a first telecommunications services criteria data related to the first company with a second telecommunications services criteria data related to the second company;
a telecommunications metric module generating a telecommunications metric related to the comparison of the first telecommunications services criteria data and the second telecommunications services criteria data;
a reporting module associated with said system computer facilitating access to the telecommunications metric thereby allowing the first company to determine how a telecommunications profile of the first company compares to a telecommunications profile of the second company.

2. The system of claim 1 wherein the telecommunications services criteria is selected from the group consisting of: directory assistance percentage; spend as a percentage of revenue; percentage spent per carrier; annual telecom spend per geographic location; spend per mobile device; percentage spent for roaming charges; percentage spent for overage charges; percentage spent for long distance charges; audit save percentage; and audit win percentage.

3. The system of claim 1 wherein the telecommunications services criteria is selected from the group consisting of: voice cost per minute; sms cost per message; data cost per megabyte; data cost per device; voice cost per device; and equipment cost per device.

4. The system of claim 1 wherein the telecommunications services criteria data of at least the first and second companies is stored on said storage.

5. The system of claim 1 wherein the telecommunications services criteria data includes usage data, expense data, and performance data;
the usage data indicative of telecommunications usage for the telecommunications service;
the expense data indicative of telecommunications expense for the telecommunications service;
the performance data indicative of telecommunications service performances.

6. The system of claim 5 wherein said comparison module compares telecommunications services criteria data having performance data within a service range for comparing telecommunications services of similar service levels.

7. The system of claim 6 wherein the service range is selectable through said interface module.

8. A system for comparing telecommunications resources a first company to telecommunications resources of a group of companies, the group of companies having a plurality of companies associated therewith, the system comprising:
a system computer having a network connection;
a storage accessible by said system computer, said storage receiving company data from the first company and each of the plurality of companies associated with the group of companies, the company data including data indicative of company sector, company industry, company revenue and the telecommunication expenditures of the companies;
the company data further associated with a telecommunications service for the first company and the group of companies wherein the company data includes telecommunications services criteria data;
an interface module allowing the first company to access said system computer with a user computer;
a comparison module receiving a comparison request from the user computer, the comparison request including a group selection indicative of the plurality of companies, wherein the plurality of companies have the same company sector, and the same industry;
the group selection further indicative of a range of revenue and a range of telecommunication expenditures wherein the plurality of companies are within the range of revenue and range of telecommunication expenditures;
the comparison request further including a criteria selection that includes telecommunications services criteria associated with a telecommunications service provided to both the first and second company;
said comparison module comparing a first telecommunications services criteria data related to the first company with a second telecommunications services criteria data related to the second company;
a telecommunications metric module generating a telecommunications metric related to the comparison of the first telecommunications services criteria data and the second telecommunication services criteria data;
a reporting module making the telecommunications metric accessible to the user computer allowing the first company to see how their telecommunication profile compares to a telecommunication profile of the second company.

9. The system of claim 8 wherein the telecommunications services criteria is selected from the group consisting of: directory assistance percentage; spend as a percentage of revenue; percentage spent per carrier; annual telecom spend per geographic location; spend per mobile device; percentage spent for roaming charges; percentage spent for overage charges; percentage spent for long distance charges; audit save percentage; and audit win percentage.

10. The system of claim 8 wherein the telecommunications services criteria is selected from the group consisting of: voice cost per minute; sms cost per message; data cost per megabyte; data cost per device; voice cost per device; and equipment cost per device.

11. The system of claim 8 wherein the telecommunications services criteria data includes usage data, expense data, and performance data;
the usage data indicative of telecommunications usage for the telecommunications service;
the expense data indicative of telecommunications expense for the telecommunications service;
the performance data indicative of telecommunications service performances.

12. The system of claim 11 wherein said comparison module compares telecommunications services criteria data having performance data within a service range for comparing telecommunications services of similar service levels.

13. The system of claim 12 wherein the service range is selectable through said interface module.

14. A system for resource comparison comprising:
a system computer having a processor with software executing thereon;
a storage accessible by said system computer, said storage for storing entity data indicative of resource profile of a plurality of entities;
software executing on said system computer for receiving a comparison request, the comparison request including a group selection and a criteria selection, the group selection indicative of at least one group of one or more entities and the criteria selection indicative of at least one criteria for comparison;
software executing on said system computer for receiving first company data relating to the criteria for the first company;
software executing on said system computer for receiving group data relating to the criteria for the at least one group of one or more entities; and
software executing on said system computer for generating a metric by comparing the first company data to the group data according to the selected at least one criteria, the metric for transmission to a user computer.

15. The system of claim 14 wherein software executing on said system computer receives the group data from a plurality of entity computers, the entity computers in communication with said system computer, the group data for transmission to said storage.

16. The system of claim 14 wherein said comparison request includes a division selection indicative of at least one division of the first company for comparison to the at least one group.

17. The system of claim 14 wherein at least a portion of the group data is received from a third party data source

18. The system of claim 14 further comprising:
an interface provided by software executing on said system computer;
a plurality of modules provided by the software of said interface, said plurality of modules comprising:
a group selection module for generating a group selection having one or more settings for selection of at least one group of one or more entities; and
a category module for generating the criteria selection having one or more criteria for comparison;
said comparison request including the category and criteria selections.

19. The system of claim 14 wherein said plurality of modules includes a resource module for generating a resource selection for selection of at least one resource; and
said comparison request further includes the resource selection;

20. The system of claim 14 further comprising:
an interface provided by software executing on said user computer;
a plurality of modules provided by the software of said interface, said plurality of modules comprising:
a group selection module for generating a group selection having one or more settings for selection of at least one group of one or more entities; and
a criteria module for generating a criteria selection having one or more criteria for comparison;
said comparison request including the category and criteria selections.

21. The system of claim 20 wherein said plurality of modules includes a resource module for generating a resource selection for selection of at least one resource; and
said comparison request further includes the resource selection;

22. The system of claim 14 wherein one of said at least one metrics is selected from the group consisting of: directory assistance percent; spend as a percentage of revenue; percent spent with top three carriers; annual telecom spend per location; total mobile spend per device; percent roaming charges; percent overage charges; percent international roaming; percent long distance charges; international roaming spend per device; audit save percentage; audit win percentage.

23. The system of claim 14 wherein one of said at least one metrics is selected from the group consisting of: voice cost per minute; sms cost per message; data cost per megabyte; data cost per device; voice cost per device; equipment cost per device.

24. The system of claim 14 wherein said at least one metrics is a telecommunications metric.

25. The system of claim 14 wherein said at least one metrics is a utility usage metric.

26. The system of claim 14 wherein said utility usage metric is selected from the group consisting of: electric charges as a percent of revenue; electric charges per location; heating charges as a percent of revenue; heating charges per location; water charges as a percent of revenue; and water charges per location.

27. The system of claim 14 wherein the group data and the first company data further comprise:
usage data;
expense data; and
performance data;
the usage data indicative of telecommunications usage for a telecommunications service;
the expense data indicative of telecommunications expense for the telecommunications service;
the performance data indicative of telecommunications service performances.

28. The system of claim 27 further comprising:
said software for generating a service range from the performance data of the first company data
wherein said group data is received according to the service range for comparison of first company data to group data according to the service range.
